(19) United States
(12) Patent Application Publication
(10) Pub. No.: US 2006/0081639 A1
(43) Pub. Date: Apr. 20, 2006

(54) Thermochromic cookware

(75) Inventors: William J. Lazaroff, Floral Park, NY (US); Alfred H. Raschdorf, Smithtown, NY (US)

Correspondence Address: JENKENS & GILCHRIST, PC, 1445 ROSS AVENUE, SUITE 3200, DALLAS, TX, 75202, US

(73) Assignee: Lifetime Hoan Corporation, Westbury, NY (US)

(21) Appl. No.: 10/965,317

(22) Filed: Oct. 14, 2004

(51) Int. Cl. A47J 37/01; A47J 27/00

(52) U.S. Cl. 220/573.1

(57) ABSTRACT

A cookware for providing a visual indication to a user to suggest if a surface of the cookware is at an elevated temperature above room temperature. The cookware includes a circular body having a first coating of paint. The circular body is further coated with a second coating of thermochromic paint having an initial color to obscure the first coating of paint. Upon heating the base of the cookware, heat is transferred to the body causing the second coating of paint to gradually change its initial color to substantially transparent causing the first coating of paint to become visible.

### BACKGROUND OF THE INVENTION

1. Technical Field of the Invention

The present invention relates in general to cooking or other activities involving heat sources and, more specifically, to cookware having a surface which provides a visual indication to a user responsive to changes in surface temperature. In particular, the present invention relates to pots, kettles, pans, and other cookware coated with a paint containing thermochromic material which changes color in response to temperature changes.

2. Description of Related Art

Cookware such as pots, kettles and pans has long been used for both commercial and home food preparation. Such cookware differs in size, materials, and sometimes intended purposes. Some of the cookware is particularly adapted for boiling water, cooking food, etc. With respect to cooking, various kinds of stoves (e.g., electric, gas, smooth cook top using glass or metal tops and toaster ovens) are well known heat sources to be used for heating the cookware. Each of these stoves and cookware present a safety problem since the surface of the cookware is hot during the cooking process and remains hot well afterwards. During the cooking process, the safety problem caused by touching the cookware is mitigated somewhat by visual inspection of the stove and the cookware. The presence of the cookware on top of the stove might alert someone to the fact that the stove appears to be in use for cooking and therefore the stove and the cookware are too hot to touch. Even the presence of a pot, kettle, pan or the like on top of the stove is not a reliable clue since some people tend to leave such items on their stove perpetually. When the cooking process has ended, it is generally impossible to detect whether the surface of the cookware is still hot (and thus might burn the skin of anyone touching it). There is no visual clue or warning to determine if the cookware is safe to touch.

To some degree, adults have developed an inherent caution when approaching stoves and cookware because of their experience and knowledge in dealing with such safety problems. This inherent caution, however, does not obviate the need for a means of warning the user about when to touch the cookware. Moreover, children usually have not developed this watchfulness. There has been a long need for a means that can prevent burn accidents to children who may inadvertently touch cookware that is hot.

None of the prevalent prior art solutions provide a safe and effective means for providing a visual clue to indicate if the surface of the cookware is safe to touch without actually touching the surface of the appliance.

Therefore, there is a need for a means for providing a visual clue or providing a visual warning to alert users that the surface of the cookware is heated and might be unsafe to touch.

### BRIEF SUMMARY OF THE INVENTION

An embodiment of the present invention concerns cookware for providing a visual clue to a user to indicate elevated surface temperature, and perhaps more specifically whether a surface of the cookware is hot and unsafe to touch. The cookware comprises a hollow circular body coated with a first coating of paint. The hollow body comprises a second coating of paint containing a thermochromic material having an initial color at ambient temperature so as to obscure the first coating of paint. The appliance further comprises a substantially flat lower surface for receiving heat and transferring heat throughout the body. The second coating of paint responds to increased temperature of the body by gradually changing the initial color in response to temperature variation and thus causing the first coating of paint to be visible.

In another embodiment of the invention, the hollow body comprises multiple coatings of paint containing the thermochromic material. The hollow body comprises a third coating of paint containing the thermochromic material having a second initial color at ambient temperature so as to obscure the second coating of paint containing the thermochromic material. Upon heating the flat lower surface, the third coating of paint responds to increased temperature of the body by gradually changing the second initial color in response to temperature variation and thus causing the second coating of paint to be visible. Upon further increase in temperature, the second coating of paint responds to increased temperature of the body by gradually changing the first initial color in response to temperature variation and thus causing the first coating of paint to be visible.

In another embodiment of the invention, the initial color changes to substantially transparent in response to temperature variation of the body above a certain value in excess of the ambient room temperature.

In yet another embodiment of the invention, the initial color changes to substantially translucent in response to temperature variation of the body above a certain value in excess of the ambient room temperature.

In another embodiment of the invention, the initial color changes to substantially colorless in response to temperature variation of the body above a certain value in excess of the ambient room temperature.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIGS. 1A-1H depict side views of a cooking kettle in accordance with the present invention illustrating a gradual change in appearance of the cooking kettle with temperature variation to reveal a flame pattern;

FIGS. 2A-2C depict side views of a cooking kettle in accordance with an alternate embodiment of the present invention illustrating multiple coatings of paint containing a thermochromic material;

FIGS. 3A-3H depict side views of a cooking kettle in accordance with the present invention illustrating a gradual change in appearance of the cooking kettle with temperature variation to reveal a plurality of letters;

FIGS. 4A-4H depict side views of a cooking kettle in accordance with the present invention illustrating a gradual change in appearance of the cooking kettle with temperature variation to reveal a chicken pattern;

FIG. 5A illustrates a right side elevational view of a cookware according to an alternate embodiment of the present invention in a cool state;

FIG. 5B illustrates a right side elevational view of a cookware according to an alternate embodiment of the present invention in a heated state;

FIG. 6A illustrates a side elevational view of a fry pan according to an alternate embodiment of the present invention in a cool state;

FIG. 6B illustrates a side elevational view of a fry pan according to an alternate embodiment of the present invention in a heated state;

FIG. 7A illustrates a side view of a cookware according to an alternate embodiment of the present invention in a cool state; and

FIG. 7B illustrates a side view of a cookware according to an alternate embodiment of the present invention in a heated state.

### DETAILED DESCRIPTION OF THE INVENTION

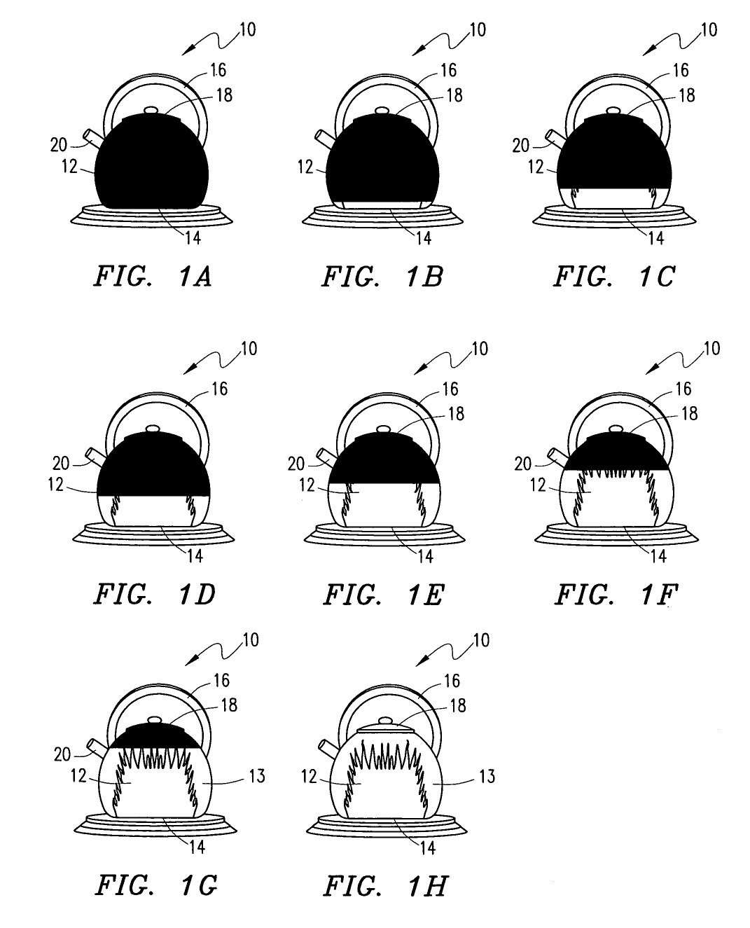

With reference now to the drawings, and in particular to FIGS. 1A-4H thereof, a novel cookware in the form of a cooking kettle embodying the principles and concepts of the present invention and generally designated by the reference numeral 10 will be described. While the embodiments described herein are illustrated as an exemplary cooking kettle 10, it will be appreciated by those skilled in the art that the present invention is not limited to kettles, and may be employed for any cookware which is heated during use (e.g., pots, pans, etc.).

Referring now to FIGS. 1A-1H, a first embodiment of the cooking kettle 10 of the present invention will be described in detail.

The cooking kettle 10 of the present invention can serve a variety of useful purposes. While the cooking kettle 10 of the present invention is suitable for heating liquids such as water, the scope of the invention extends to any cooking activity that involves heat transfer and heated surfaces of an appliance or cookware for a variety of cooking purposes.

The cooking kettle 10 includes a body 12 which is substantially circular in shape. The circular configuration of the cooking kettle 10 is abruptly terminated along its lower surface, the proximity of which is designated at 14, permitting the cooking kettle 10 to rest on a flat surface, such as countertops, stoves etc. The lower surface 14 is substantially flat and disc-shaped which abuts a stove burner during the cooking process. According to an embodiment of the present invention, the body 12 of the cooking kettle 10 is made of a uniform heat conductive material such as aluminum. The kettle 10 is sized to fit on a conventional stove that can be either gas or electric. The cooking kettle 10 further includes a handle 16 and a lid 18 that rests on the top surface of the body 12. The body 12 is a hollow container and includes a spout 20 thereon. The handle 16 is substantially arcuate and mounted on an upper side of the body 12. According to an embodiment of the present invention, the handle 16 is made of a thermally insulative material (e.g., rubber, plastic etc.).

The body 12 of the cooking kettle is painted, decorated or glazed with a first coating of paint in a conventional manner. The first coating may include multiple colors and may have a pattern such as a series of flowers or any other pattern that would make the kettle attractive. According to an embodiment of the present invention, the body 12 of the cooking kettle 10 is preferably spray painted. However, the body 12 of the cooking kettle 10 can be painted using a brush or any other suitable technique. According to an embodiment of the present invention, the body 12 has been painted to represent a flame pattern 13.

After the application of the first coating of paint on the body 12 of the cooking kettle 10, the paint is allowed to dry. The drying time varies depending upon the paint used and the surface area of the body 12. Once dry, a second coating of paint containing thermochromic material (TC) is applied on the body 12 of the cooking kettle 10. According to another embodiment of the present invention, the body 12 can be painted with multiple coatings of paint containing thermochromic materials to represent a series of color changes.

There are two types of TC's, liquid crystals and leuco dyes. Liquid crystals are used in a variety of products which include aquarium thermometers, stress testers, forehead thermometers etc. While liquid crystals are extremely accurate, they are extremely complicated and sensitive to work with and require highly specialized manufacturing techniques. The second type of TC (leuco dye) is commonly used in security printing, and novelty applications such as temperature sensitive plastics, mugs, product labels, advertising specialties, and textiles.

According to an embodiment of the present invention, the second coating of paint includes thermochromic material (leuco-dye) which is applied to the entire body 12 of the cooking kettle except the base 14 and the handle 16. Thermochromic material (leuco-dye) is a material which is opaque at ambient room temperature and at a specified elevated temperature changes color, or becomes transparent or at least translucent. In general, thermochromic material changes color from a darker color to a lighter color or changes to colorless when they are heated through a defined temperature range.

Since the thermochromic material changes color as the temperature rises, the appearance of the cooking kettle 10 gradually changes with temperature variation due to the presence of the second coating of paint containing thermochromic material on its surface 12. According to an embodiment of the present invention, temperature variation can be accomplished by heating the base 14 of the cooking kettle 10 on a stove, however, other suitable methods may be employed (such as using heated or cold air, heated brushes, immersion of kettle 10 in hot or cold water, etc or any other suitable means) to vary the temperature of the body 12. As the base 14 of the cooking kettle 10 is heated, heat is conducted upwardly throughout the conductive body 12 of the cooking kettle 10. The conduction of heat causes the temperature of the body 12 to rise. This causes the temperature of the thermochromic material to rise, thus, resulting in a change of color and perhaps revealing the first coating of paint.

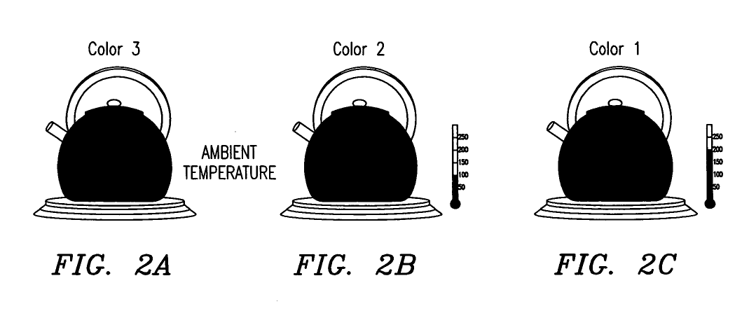

FIGS. 2A-2C illustrate an alternate embodiment of the present invention. The body 12 of the cooking kettle 10 is not limited to a single coating of paint containing thermochromic material and may include multiple coatings of paint containing the thermochromic material. The body of the cooking kettle 10 is painted, decorated or glazed with a first coating of paint in a conventional manner. The first coating of paint may include multiple colors or a single color (e.g., yellow). Once dry a second coating containing thermochromic material is applied to the body 12 of the cooking kettle 10. This second coating has a color other than the first coating color (for example, orange) at ambient room temperature. A third coating of paint containing thermochromic material is further applied to the body 12 of the cooking kettle 10. This third coating has a color other than the first or second coating colors (for example, red) at ambient room temperature. Thus, at room temperature, the kettle 10 is red in color. When the base 14 of the body 12 is heated, the temperature of the body gradually rises due to transfer of heat upwardly throughout the conductive body 12 of the cooking kettle 10. The elevated temperature of the body 12 causes the third coating of paint containing the thermochromic material to gradually change to substantially transparent at a second clearing temperature such that the second coating of paint containing the thermochromic paint (orange) can be clearly seen. As the temperature of the body 12 continues to rise, the second coating of paint containing the thermochromic paint (orange) gradually changes to substantially transparent at a first clearing temperature (greater than the second clearing temperature) such that the first coating of paint can be clearly seen (yellow).

One purpose of using thermochromic paint on cooking kettles 10 is to provide a visual indication to the user of whether the surface of the kettle is unsafe to touch. Another purpose of using thermochromic paint on cooking kettles 10 is for decorations. The decorations may include a pattern to represent a series of fruits, flowers or any other design to make the kettle 10 attractive. As an exemplary embodiment, the body of the kettle 10 can be decorated with a first coating of paint in a conventional manner so as to represent a series of flames 13. The flames 13 indicate that the surface of the kettle 10 is hot and unsafe to touch. A second coating of paint is applied to the body 12 of the cooking kettle 10 such that the body 12 is covered with the paint containing thermochromic material. This may be accomplished by using a dark colored paint containing leuco dye which in color change becomes clear, transparent, or colorless as the temperature of the body 12 is heated to a certain temperature level revealing an underlying coating of paint (first coating). At room temperature, the kettle 10 is a dark color (such as blue, black). When the base 14 of the body 12 is heated, the temperature of the body 12 gradually rises due to transfer of heat to an outer circumferential surface of the body 12 causing the thermochromic paint to gradually change to a substantially transparent state such that the flame pattern 13 beneath the second coating of paint containing the thermochromic paint (leuco dye) can be clearly seen. As the kettle 10 subsequently cools, the temperature of the body 12 drops resulting in the dark color 15 of the thermochromic paint to reappear to obscure the flame pattern. Thus, when the body 12 of the cooking kettle 10 is hot, the first coating of paint representing the flame pattern 13 is visible. This provides a visual clue to the user that the surface of the cooking kettle 10 is hot and might be unsafe to touch. It is important to point out that any portion of the body 12 or the entire body 12 may be painted with the first coating of paint to represent any desirable design, pattern, number, letter or indicia.

The second coating of paint containing thermochromic dye preferably comprises a two-part epoxy, including a dye (LD-X) and a thinner. LD-X ink is supplied in two parts (base and catalyst). The ink and catalyst are mixed thoroughly before the addition of thinner. The ink is preferably of different colors and changes color at different temperatures. According to an exemplary embodiment, the ink and the catalyst are mixed together in the following ratios: LD-X 75% by weight and catalyst 25% by weight.

The second coating of paint containing LD-X dries by solvent evaporation combined with a chemical reaction between a base and the catalyst. Air drying times are usually longer and may last up to five hours. According to an embodiment of the present invention, the second coating of paint containing LD-X is dried by passing the cooking kettle 10 through a shortwave infrared drier or a gas convection oven for five to eight minutes at 150° C., or ten to fifteen minutes at 120° C., or twenty to thirty minutes at 80° C.

The LD-X has fifteen base colors. By combining LD-X with regular permanent color pigments, a change from one color when cool to another color when hot is possible. According to an exemplary embodiment, a blue LD-X combined with a yellow regular permanent pigment will change from green when cool to yellow when warm. The available base colors for the LD-X are as follows: Red, Rose Red, Magenta, Vermillion, Orange, Yellow, Yellow Green, Charm Green, Green, Sky Blue, Turkish Blue, Blue, Dark Blue, Violet, and Black.

Standard activation temperatures at which color change occurs are 15° C., 31° C., and 45° C., however, other activation temperatures are also available from −5° C. to 65° C. Activation temperature is defined as the temperature above which the leuco-dye has completely changed its color to transparent or a lighter color (clearing point). According to an embodiment of the present invention, leuco-dyes with clearing points below 34° C. change from colored state to clear state over a 2-4° C. range about the clearing point. Additionally, with leuco-dyes having clearing points above 34° C., the leuco-dyes change from colored state to clear state over a 5-8° C. range about the clearing point. Because many different activation temperatures (clearing points) are available, one may select a different clearing point for each applied thermochromic paint layer. As discusses above, two or more thermochromic layers may be applied over a base layer. If each of those layers have a different clearing point, the cookware will respond to applied heat by shifting through many different colors, with each color providing a separate indication of relative temperature.

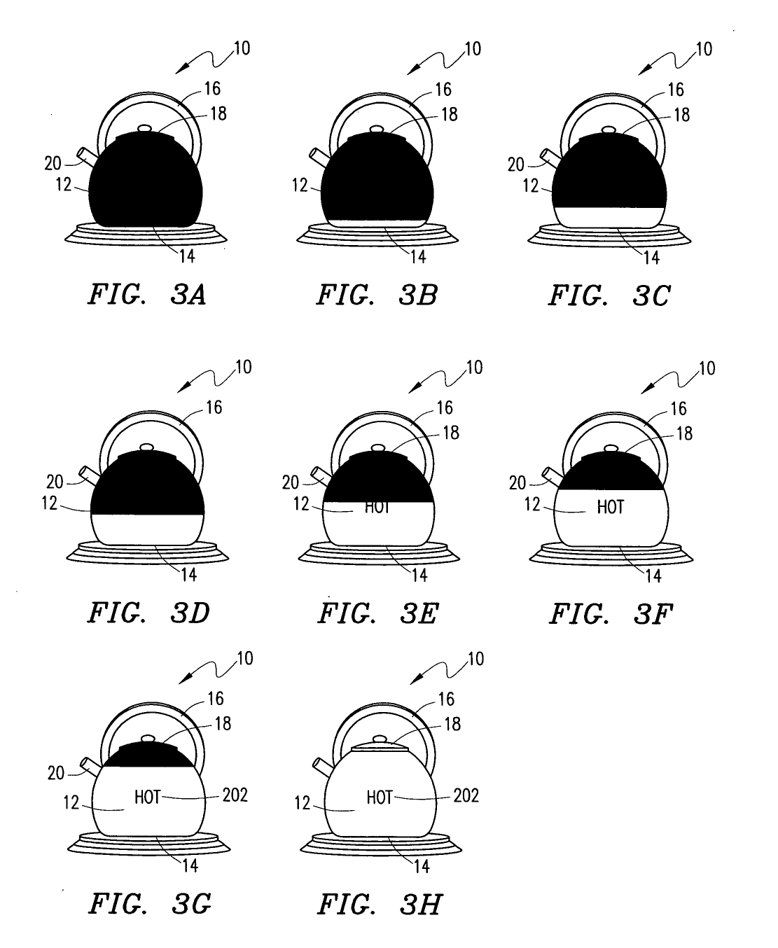

FIGS. 3A-3H illustrate an alternate embodiment embodying a variation of design on the body 12 of the cooking kettle 10. In this embodiment, the body 12 of the cooking kettle 10 is painted with a first coating of paint in a conventional manner so as to represent a variety of letters 202.

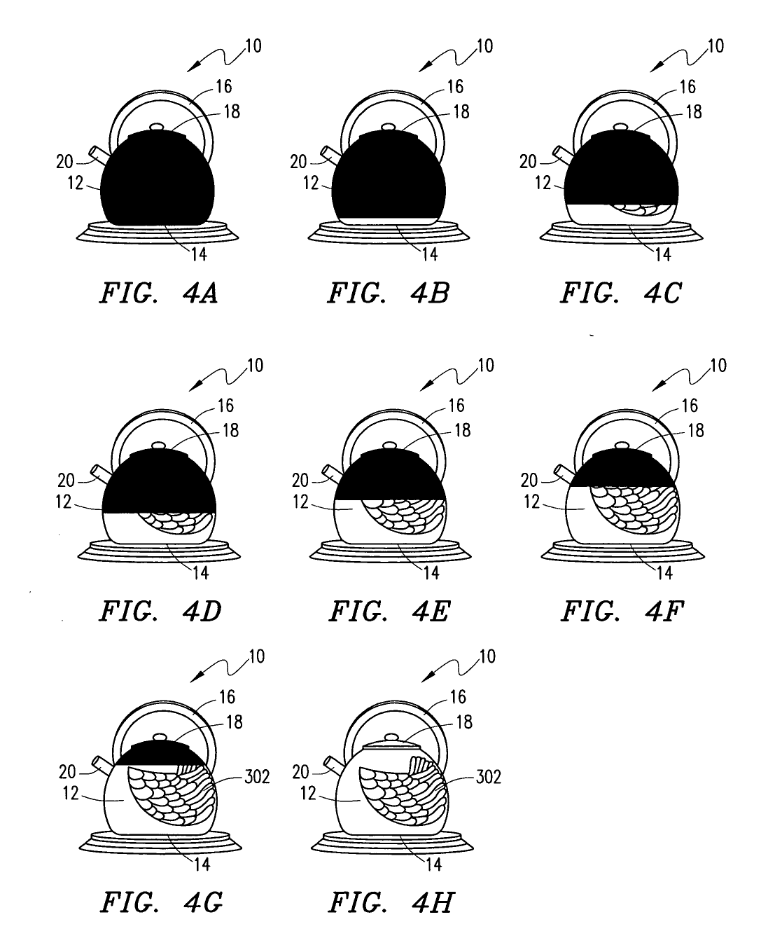

FIGS. 4A-4H illustrate an alternate embodiment embodying a decorative design on the body 12 of the cooking kettle 10. In this embodiment, the body 12 of the cooking kettle 10 is painted with a first coating of paint in a conventional manner so as to represent a design such as a chicken pattern 302.

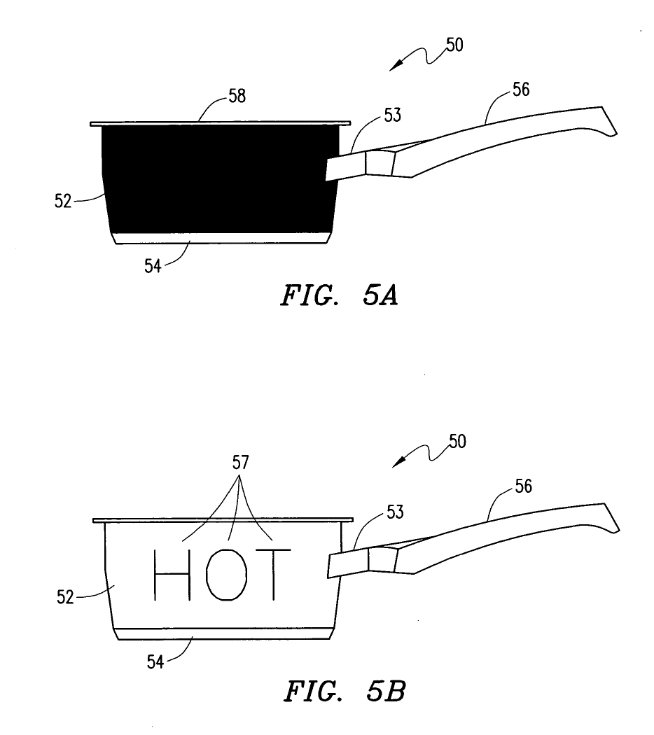

FIGS. 5A-5B illustrate an alternate cookware for cooking. More specifically, FIG. 5A depicts a cookware in the form of a cooking pan 50 for cooking pasta, chicken, soup or any other food product. The cooking pan 50 includes a circular body 52 which is made of a heat conductive metal such as aluminum that includes a handle fastener 53. The circular configuration of the cooking pan 50 is terminated along its lower surface, the proximity of which is designated at 54, permitting the cooking pan 50 to rest on a flat surface, such as countertops and stoves etc. The lower surface 54 is substantially flat and abuts a stove burner during the cooking process. The cooking pan 50 further includes a handle 56 and an optional lid (not shown) that can rest on the top surface of the body 52. The handle 56 is mounted on the body 52 by means of the fastener 53.

The body 52 of the cooking pan is painted, decorated or glazed with a first coating of paint in a conventional manner. This first coating of paint may include multiple colors and may have a pattern such as a series of flowers or any other pattern that would make the cooking pan 52 attractive. According to an embodiment of the present invention, the body 52 of the cooking pan 50 is painted to represent the letters HOT represented by reference numeral 57. After the first coating of paint is allowed to dry, the body 52 of the cooking pan 50 is painted using a dark colored second coating of paint 58 containing thermochromic material (leuco dye). According to an embodiment of the present invention, the first and second coating of paint is applied to the body 52 of the cooking pan 50 by spray painting. However, the body 52 of the cooking pan 50 can be painted using a brush or any other suitable technique. In an embodiment, multiple layers of thermochromic material, each having a different ambient color and clearing point may be applied.

At ambient room temperature, the cooking pan 50 is a dark color 58 (such as blue, black) (FIG. 5A). When the base 54 of the cooking pan 50 is heated, the temperature of the body 52 gradually rises due to conduction of heat causing the second coating of paint 58 containing the thermochromic dye to change to a substantially transparent state resulting in the pattern of letters HOT 57 beneath the second coating of paint 58 becoming visible (FIG. 5B). As the cooking pan 50 subsequently cools, the temperature of the body 52 drops resulting in the dark color 58 to reappear to obscure the pattern of letters HOT 57 (FIG. 5A). Thus, when the body 52 of the cooking pan 50 is hot, the first coating of paint representing the pattern of letters is visible. This provides a visual clue to the user that the bottom of the cooking pan 52 has been exposed to heat and the surface 52 of the cooking pan 50 has an elevated temperature and may be hot and unsafe to touch. It is important to note that the body 52 of the cooking pan 50 may be painted with the first coating of paint to represent any desirable design, pattern, warning sign, or indicia.

According to embodiments of the present invention, the cookware has been disclosed as having a single coating of paint containing thermochromic paint. However, the cookware can be coated with multiple coatings of paint containing thermochromic paint for decorative purposes. Preferably, each coating has a different ambient temperature color and a different clearing point.

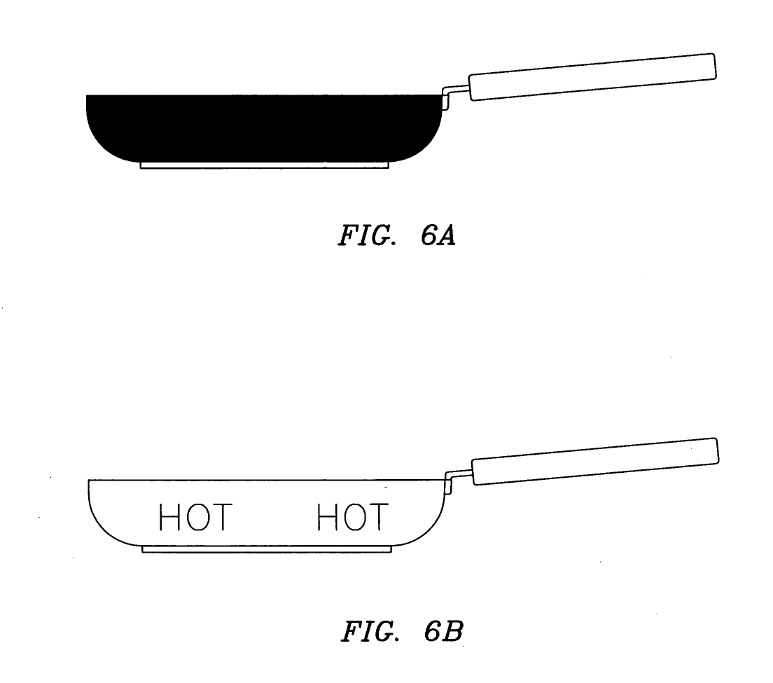

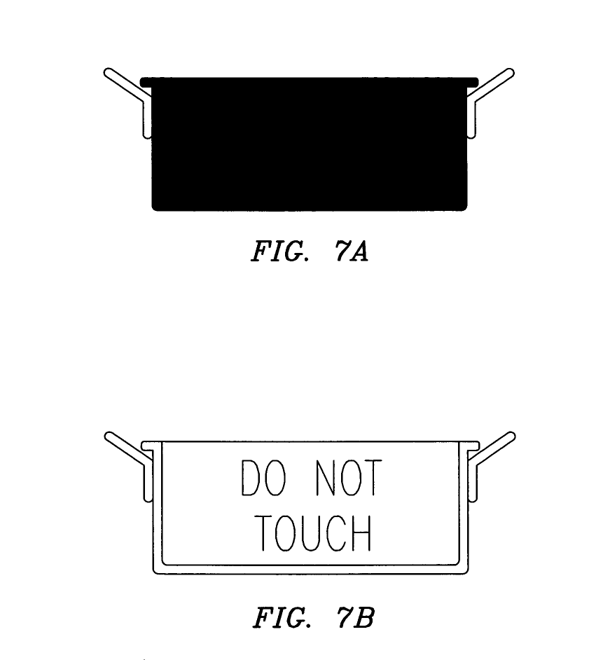

According to embodiments of the present invention, cooking kettles and cooking pans have been disclosed. However, the novel concept as discussed above can be applied to any other cookware that can be externally heated for cooking purposes. Additionally, the novel concept of applying a first coating of paint in a conventional manner and applying a second coating of paint containing thermochromic materials for warning purposes can be utilized in various forms and types of cookware that are available. As an exemplary embodiment, a few variations of cookware are illustrated in FIGS. 6A-7B.

Although various embodiments of the different kinds and shapes of a plurality of cookware of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A cookware for providing a visual indication to a user to suggest elevated surface temperature of the cookware above ambient room temperature, the cookware comprising:
a hollow circular body coated with a first coating of paint;
the hollow circular body coated with a second coating of paint containing a thermochromic material having a first initial color at the ambient room temperature which obscures the first coating of paint;
a substantially flat lower surface for receiving heat and conducting the heat to the body; and
the second coating of paint for gradually changing the first initial color in response to temperature variation of the body above a certain value in excess of the ambient room temperature.

2. The cookware of claim 1 further comprising:
a handle mounted on an upper side of the body;
a lid resting on a top surface of the body; and a spout region.

3. The cookware of claim 2, wherein the handle is made from a thermally insulative material.

4. The cookware of claim 1, wherein the body is made from a uniform heat conductive material.

5. The cookware of claim 4, wherein the body is made from aluminum.

6. The cookware of claim 1, wherein the first and second coating of paint are applied to the body by spraying.

7. The cookware of claim 6, wherein the first and second coating of paint are applied to the body by a paint brush.

8. The cookware of claim 1, wherein the first coating of paint represents a first pattern.

9. The cookware of claim 8, wherein the first pattern represents a flame pattern.

10. The cookware of claim 9, wherein the first pattern represents a series of alphabets.

11. The cookware of claim 10, wherein the first pattern represents multiple colors for decoration.

12. The cookware of claim 11, wherein the first pattern represents a series of flowers.

13. The cookware of claim 1, wherein the first initial color is a dark color at the ambient room temperature.

14. The cookware of claim 13, wherein the first initial color gradually changes to a first color state at a first clearing temperature resulting in the first coating of paint to become visible.

15. The cookware of claim 14, wherein the first color state is substantially transparent at the first clearing temperature.

16. The cookware of claim 15, wherein the first color state is substantially translucent at the first clearing temperature.

17. The cookware of claim 16, wherein the first color state is substantially colorless at the first clearing temperature.

18. The cookware of claim 17, wherein the first clearing temperature is higher than the ambient room temperature.

19. The cookware of claim 14, wherein the gradual color change provides the visual indication to the user of the elevated surface temperature.

20. The cookware of claim 19, the gradual color change provides the visual indication to the user that the cookware is unsafe to touch.

21. The cookware of claim 20, wherein the thermochromic material comprises a two part epoxy including leuco-dye (LDX) and thinner.

22. The cookware of claim 21, the leuco-dye comprises a base and a catalyst.

23. The cookware of claim 22, wherein the first clearing point varies for different leuco-dyes.

24. The cookware of claim 23, wherein the leuco-dyes having clearing points below 34° C. change from the first initial color to the first color state over a 2-4° C. range about the first clearing point.

25. The cookware of claim 23, wherein the leuco-dyes having clearing points above 34° C. change from the first initial color to the first color state over a 5-8° C. range about the first clearing point.

26. The cookware of claim 1, wherein the cookware is a cooking kettle.

27. The cookware of claim 1, wherein the cookware is a cooking pan.

28. The cookware of claim 1, wherein the cookware is a cooking pot.

29. The cookware of claim 14, wherein upon cooling the body from the first clearing temperature to the ambient room temperature a gradual transition to the first initial color occurs.

30. The cookware of claim 14, further comprising:
the hollow circular body being coated with a third coating of paint containing the thermochromic material having a second initial color at the ambient room temperature which obscures the second coating of paint.

31. The cookware of claim 30, wherein the third coating of paint gradually changes from the second initial color at a second clearing temperature resulting in the second coating of paint to become visible.

32. The cookware of claim 31, wherein the second clearing temperature is higher than the second clearing temperature.

33. The cookware of claim 32, wherein the third coating of paint has a color other than the second coating of paint.

34. A cookware comprising:
a substantially flat lower surface for receiving heat and conducting the heat to a hollow circular body;
the hollow circular body having on an outer surface with a first coating of paint; and
the outer surface of the hollow circular body having a second coating of paint containing a thermochromic dye to indicate by its color change an elevated surface temperature of the cookware above ambient room temperature.

35. The cookware of claim 30, wherein the body is made from a uniform heat conductive metal.

36. The cookware of claim 35, wherein the body is made from aluminum.

37. The cookware of claim 34, wherein the first and second coating of paint are applied to the body by spraying.

38. The cookware of claim 37, wherein the first and second coating of paint are applied to the body by a paint brush.

39. The cookware of claim 34, wherein the first coating of paint represents a first pattern.

40. The cookware of claim 39, wherein the first pattern represents a flame pattern.

41. The cookware of claim 40, wherein the first pattern represents a series of alphabets.

42. The cookware of claim 41, wherein the first pattern represents a series of flowers.

43. The cookware of claim 34, wherein the second coating of paint has a first initial color at the ambient room temperature.

44. The cookware of claim 43, wherein the first initial color is substantially dark and obscures the first coating of paint.

45. The cookware of claim 44, wherein the first initial color changes to substantially transparent at a first clearing temperature resulting in the first coating of paint to become visible.

46. The cookware of claim 45, wherein the first initial color changes to substantially translucent at the first clearing temperature.

47. The cookware of claim 46, wherein the first initial color changes to substantially colorless at the first clearing temperature.

48. The cookware of claim 47, wherein the first clearing temperature is a certain value in excess of the ambient room temperature.

49. The cookware of claim 34, wherein the cookware is a cooking kettle.

50. The cookware of claim 34, wherein the cookware is a cooking pan.

51. The cookware of claim 45, further comprising:
the hollow circular body being coated with a third coating of paint containing the thermochromic dye having a second initial color at the ambient room temperature which obscures the second coating of paint.

52. The cookware of claim 51, wherein the third coating of paint gradually changes from the second initial color at a second clearing temperature resulting in the second coating of paint to become visible.

53. The cookware of claim 52, wherein the second clearing temperature is higher than the ambient room temperature.

54. The cookware of claim 52, wherein first clearing temperature is greater than the second clearing temperature.

55. The cookware of claim 52, wherein the third coating of paint has a color other than the second coating of paint.

56. A cookware for providing a visual indication to a user to suggest elevated surface temperature of the cookware above ambient room temperature, the cookware comprising:
a hollow circular body coated with a first coating of paint;
the hollow circular body coated with a second coating of paint containing a thermochromic material having a first initial color at the ambient room temperature which obscures the first coating of paint;
the hollow circular body coated with a third coating of paint containing the thermochromic material having a second initial color at the ambient room temperature which obscures the second coating of paint;
a substantially flat lower surface for receiving heat and conducting the heat to the body;
the third coating of paint for gradually changing the second initial color in response to temperature variation of the body above a first value in excess of the ambient room temperature; and
the second coating of paint for gradually changing the first initial color in response to temperature variation of the body above a second value in excess of the ambient room temperature.
